(19) United States
(12) Patent Application Publication
(10) Pub. No.: US 2014/0055420 A1
(43) Pub. Date: Feb. 27, 2014

(54) DISPLAY IDENTIFICATION SYSTEM AND DISPLAY DEVICE

(71) Applicant: Samsung Electronics Co., Ltd., Suwon-si (KR)

(72) Inventors: Atsuya YOKOI, Yokohama-shi (JP); Sang-on CHOI, Suwon-si (KR)

(73) Assignee: Samsung Electronics Co., Ltd., Suwon-si (KR)

(21) Appl. No.: 13/974,715

(22) Filed: Aug. 23, 2013

(30) Foreign Application Priority Data
Aug. 23, 2012 (JP) 2012-184315
May 9, 2013 (JP) 10-2013-0052753

(51) Int. Cl. G06F 3/0354

(52) U.S. Cl. CPC G06F 3/03545
USPC 345/175

(57) ABSTRACT

A display identification system includes: a plurality of display devices, each of the display devices having a light source; and an identification device configured to identify the plurality of display devices. Each of the plurality of display devices includes a configured to perform luminance modulation to luminance-modulate an output light of the corresponding light source in a predetermined range, by combining a specific signal, which is different for each of the display devices, with a driving signal of the corresponding light source. The identification device includes: a receiver configured to receive an optical signal obtained by performing the luminance modulation; and an identification device configured to identify the plurality of display devices based on the optical signal received by the receiver.

### CROSS-REFERENCE TO RELATED PATENT APPLICATIONS

This application claims the benefit of Japanese Patent Application No. 2012-184315, filed on Aug. 23, 2012, in the Japanese Intellectual Property Office, and Korean Patent Application No. 10-2013-0052753, filed on May 9, 2013, in the Korean Intellectual Property Office, the disclosures of which are incorporated herein in their entirety by reference.

### BACKGROUND

1. Field

The present disclosure relates to a display identification system and a display device.

2. Description of the Related Art

Recently, with the increase in production of mobile electronic devices, a touch screen input method in which an input operation is performed by touching a screen with a finger or a touch pen, in addition to a conventional input method using a keyboard or a mouse, has become widely used.

A light pen may be mounted with a camera as a kind of touch pen. The light pen receives light corresponding to a specific pattern formed on a display. A position of the light pen may be detected according to the reception of the light, and thus, a text input operation is enabled. For example, the specific pattern may be formed as a dot-shaped paint for absorbing infrared rays, which may be arranged on the display according to a predetermined rule.

In addition, the position of the light pen may be detected by dividing the display into a plurality of blocks and then emitting different colored lights for each of the blocks and receiving the lights with the light pen, instead of forming a specific pattern on the display (for example, as disclosed in Japanese patent application publication No. 2003-015820).

When an input method using a light pen (hereinafter, referred to as “a light pen input method”) is used, a position of a light pen on a display may be accurately detected. Thus, recently, the light pen input method has also been developed for use for a large screen interactive white board (IWB) formed by arranging a plurality of displays.

However, generally, when the displays forming the IWB are all the same kind, the same pattern is formed on the plurality of displays when detecting a position of a light pen. In addition, with respect to a display disclosed in the Japanese patent application publication No. 2003-015820, if a plurality of displays are the same kind of displays, colors of lights that are emitted from blocks are the same when detecting a position of a light pen.

Accordingly, in a conventional technique of using an IWB having a plurality of displays which are the same kind and which are arranged side by side, it is not possible to identify each individual display. In addition, when a light pen input method is used, it is not possible to identify a display on which an input by a light pen should be displayed.

### SUMMARY

The exemplary embodiments provide a display identification system for identifying a display device, on which an input by a light pen is to be displayed, when a light pen input method is used in a system including a plurality of display devices.

The exemplary embodiments also provide a display device that is identified by an identification device.

According to an aspect of the exemplary embodiments, there is provided a display identification system including: a plurality of display devices, each of the display devices having a light source; and an identification device configured to identify the plurality of display devices, wherein each of the plurality of display devices includes a modulator configured to perform luminance modulation to luminance-modulate an output light of the corresponding light source in a predetermined range, by combining a specific signal, which is different for each of the display devices, with a driving signal of the corresponding light source, and wherein the identification device includes: a receiver configured to receive an optical signal obtained by performing the luminance modulation; and an identification device configured to identify each of the plurality of display devices based on the optical signal received by the receiver.

According to aspects of the exemplary embodiments, a different specific signal for each display may be combined with a signal for driving a backlight of each display. Accordingly, an output light of the backlight is luminance-modulated. By analyzing an optical signal obtained by the luminance modulation by using a light pen, a display toward which the light pen points may be specified. Also, in an interactive white board (IWB) including a plurality of displays, a display toward which a light pen points may be accurately specified and an input result by the light pen may be accurately displayed on the specified display.

### BRIEF DESCRIPTION OF THE DRAWINGS

The above and other features and advantages of the present disclosure will become more apparent by describing in detail exemplary embodiments thereof with reference to the attached drawings in which:

FIG. 1 is a block diagram illustrating an example of a hardware configuration of a display identification system according to an exemplary embodiment;

FIG. 2 is a diagram illustrating an example of a pattern that is formed on the surface of a display according to an exemplary embodiment;

FIG. 3 is a diagram illustrating an example of a detailed hardware configuration of a backlight modulator according to an exemplary embodiment;

FIG. 4 shows graphs that each illustrate a frequency spectrum of a sinusoidal wave signal generated by a sinusoidal wave signal generator according to an exemplary embodiment;

FIG. 5 is a graph illustrating a frequency spectrum of an optical signal received by an identification device according to an exemplary embodiment;

FIG. 6 is a diagram illustrating an example of a backlight (e.g., an optical signal) frequency-modulated by a display identification (ID) according to an exemplary embodiment; and

FIG. 7 is a diagram illustrating an example of a backlight (an optical signal) phase-modulated by a display identification (ID) according to an exemplary embodiment.

### DETAILED DESCRIPTION

Hereinafter, the present disclosure will be described in detail by explaining exemplary embodiments with reference to the attached drawings. Like reference numerals in the drawings denote like elements. Expressions such as “at least one of,” when preceding a list of elements, modify the entire list of elements and do not modify the individual elements of the list.

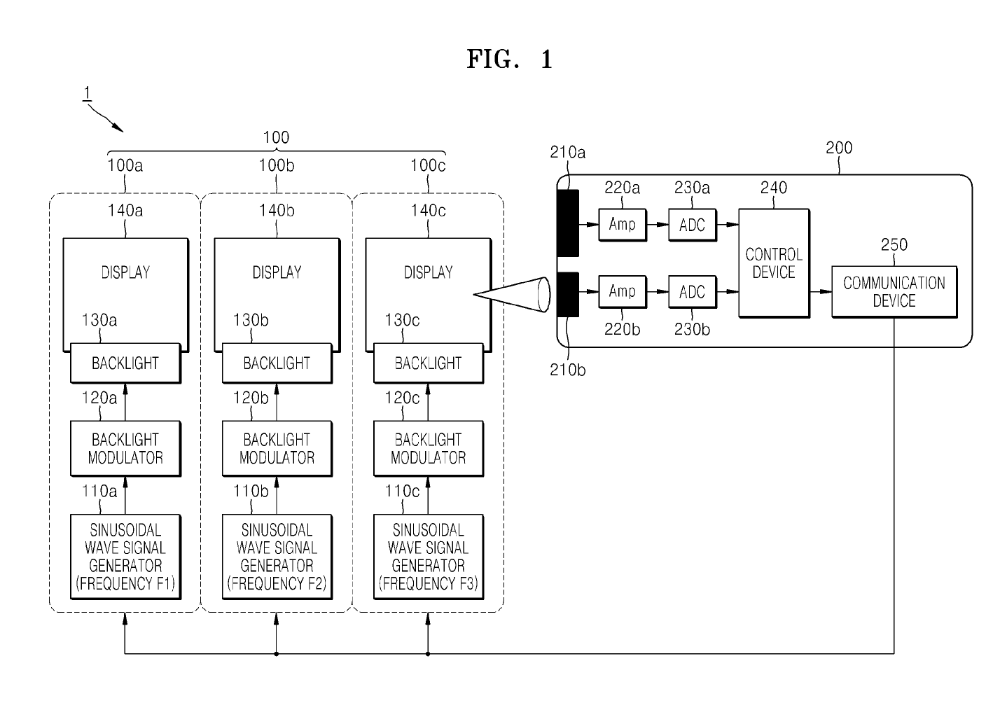

FIG. 1 is a block diagram illustrating an example of a hardware configuration of a display identification system 1 according to an exemplary embodiment.

As illustrated in FIG. 1, the display identification system 1 includes a plurality of display devices 100 and an identification device 200 for identifying the plurality of display devices 100.

In FIG. 1, three display devices, that is, a first display device 100a, a second display device 100b, and a third display device 100c, are arranged side by side, thus forming a large screen interactive white board (IWB). It is understood that more or less than three display devices may be used according to other exemplary embodiments.

The identification device 200 may be implemented as, for example, a pointing device such as a light pen, and identifies the display devices 100, toward which the front end part of the identification device 200 is directed, and simultaneously specifies a position or movement of the identification device 200 on the identified display devices 100.

When a user uses the display identification system 1 by performing an operation in which the user holds the identification device 200 by hand and then moves the identification device 200 as if writing a character on an IWB, the character may be displayed on the display device 100 toward which the front end part of the identification device 200 is directed.

Detailed hardware configurations of the display devices 100 and the identification device 200, which constitute the display identification system 1, will be described below. The first through third display devices 100a, 100b, and 100c have the same configuration except for a portion described below, and thus, only the first display device 100a will be representatively described below.

As illustrated in FIG. 1, the first display device 100a includes a sinusoidal wave generator 110a, a backlight modulator 120a, a backlight 130a, and a display 140a.

The sinusoidal wave generator 110a is a circuit that generates a specific signal having characteristics that are different from those of other display devices, that is, the second display device 100b and the third display device 100c, which form part of the IWB. For example, the sinusoidal wave generator 110a of the first display device 100a generates a sinusoidal wave signal having a first frequency f1.

In addition, a sinusoidal wave generator 110b of the second display device 100b generates a sinusoidal wave signal having a second frequency f2 that is different from the first frequency f1 (for example, f1<f2). A sinusoidal wave generator 110c of the third display device 100c generates a sinusoidal wave signal having a third frequency f3 that is different from the first frequency f1 and the second frequency f2 (for example, f2<f3).

A value of each of the first, second, and third frequencies f1, f2, and f3 is set within a range in which viewers cannot recognize light having a luminance which changes at each frequency. For example, each of the frequencies f1, f2, and f3 is set to 1 KHz or more. In addition, each of the frequencies f1, f2, and f3 is set to be within a range in which a backlight to be described later is operable, for example, a range of 10 MHz or less. According to exemplary embodiments, a minimum value and a maximum value of each of the frequencies f1, f2, and f3 may be values selected to be used based on a display technology implemented by displays 140a, 140b and 140c, for example, a case where a liquid crystal display (LCD) is used as each of the displays 140a, 140b, and 140c, and may be changed according to a display technology to be used. For example, if an electro luminescence (EL) display is used as each of the displays 140a, 140b, and 140c, each of the frequencies f1, f2, and f3 may be a value that is 100 kHz or more and 1 MHz or less.

The backlight modulator 120a modulates the luminance of light that is output from the backlight 130a to be described later. In detail, the backlight modulator 120a may modulate the luminance of the light, which is output from the backlight 130a, by combining a specific signal (for example, a sinusoidal signal having the first frequency f1) generated by the sinusoidal wave generator 110a with a driving signal for driving the backlight 130a.

The backlight 130a is a light source that is mounted on the back of the display 140a. For example, a light emitting diode (LED) is used as the backlight 130a.

According to exemplary embodiments, the display 140a is implemented as an LCD. The display 140a displays an image by partially blocking or transmitting the light that is output from the backlight 130a. It is understood that the display 140a is not limited to being implemented as an LCD.

A specific pattern is formed on the surface of the display 140a. For example, a dot-shaped paint for absorbing infrared rays is arranged on the surface of the display 140a according to a predetermined rule, and thus, a specific pattern is formed.

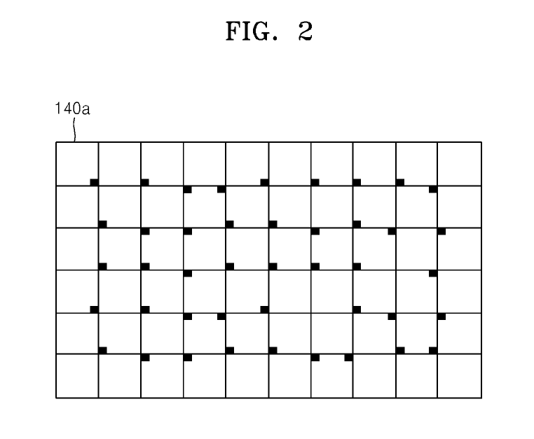

FIG. 2 is a diagram illustrating an example of a pattern that is formed on the surface of the display 140a according to an exemplary embodiment. As illustrated in FIG. 2, the surface of the display 140a is divided into a plurality of blocks, and the number of dots (points absorbing infrared rays) that are formed in each block varies with each block. Thus, different shapes (patterns) are formed at different positions on the surface of the display device 140a. As a corresponding shape (pattern) is recognized by the identification device 200, a location or a movement of the identification device 200 may be specified on the display 140a.

Next, the backlight modulator 120 will be described in detail.

Three backlight modulators 120a, 120b, and 120c disposed in the three display devices 100a, 100b, and 100c have the same configuration as each other except that characteristics (for example, frequencies) of specific signals, which are input from the respective sinusoidal wave generators 110a, 110b, and 110c and received by the three backlight modulators 120a, 120b and 120c, are different. Thus, only the backlight modulator 120a disposed in the first display device 100a will be representatively described below.

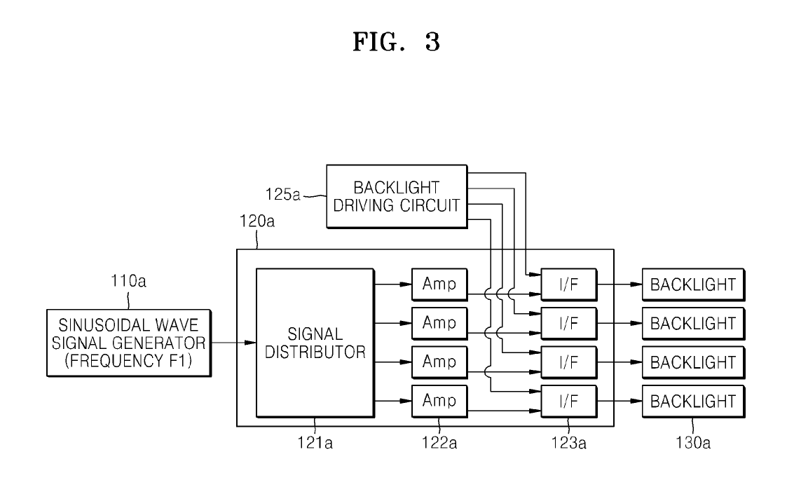

FIG. 3 is a diagram illustrating an example of a detailed hardware configuration of the backlight modulator 120a according to an exemplary embodiment.

The display device 100a includes a backlight 130a having a plurality of channels to uniformly light the display 140a. In the example of FIG. 3, the display device 100a includes the backlight 130a having four channels.

The backlight modulator 120a includes a signal distributor 121a, four amplifiers 122a, and four interfaces 123a, as illustrated in FIG. 3.

The signal distributor 121a distributes a specific signal received from the sinusoidal wave generator 110a to each of the four amplifiers 122a.

Each of the amplifiers 122a amplifies the specific signal received from the signal distributor 121a to obtain a power that is used for luminance modulation, and supplies the amplified specific signal to a corresponding interface of the four interfaces 123a.

In addition, although not illustrated in FIG. 1, backlight driving circuits 125a, 125b, and 125c for driving the backlights 130a, 130b, and 130c are mounted in the display devices 100a, 100b, and 100c, respectively.

The backlight driving circuit 125a may supply the same driving signal to the four interfaces 123a. The driving signal that is supplied to each of the interfaces 123a by the backlight driving circuit 125a may be, for example, a direct current (DC). However, the exemplary embodiments are not limited thereto, and the driving signal may be a pulse signal.

In this manner, the driving signal received from the backlight driving circuit 125a and the amplified specific signal from a corresponding amplifier of the four amplifiers 122a are input to each of the four interfaces 123a.

Each of the interfaces 123a is implemented as, for example, a transformer coupled circuit or a condenser coupled circuit, and AC-couples the received driving signal and the received specific signal and then supplies the AC-coupled signal to a corresponding backlight 130a.

By such an operation, the driving signal input from the backlight driving signal 125a is luminance-modulated with a specific signal unique to each display device 100, and the luminance-modulated driving signal is supplied to the backlight 130a.

When the luminance-modulated driving signal is supplied to the backlight 130a, the backlight 130a emits an output light (e.g., an optical signal) based on the supplied driving signal.

The driving signal luminance-modulated by the interface 123a includes a DC current component (or a pulse signal component) generated in the backlight driving circuit 125a and a sinusoidal wave component generated in the sinusoidal wave generator 110a.

Accordingly, the backlight 130a outputs an optical signal, which has a constant average luminance that is determined by the DC current component included in the driving signal, and which has a luminance which is momentarily changed by a sinusoidal wave component that is different for each display device 100.

Next, the identification device 200 will be described.

As illustrated in FIG. 1, the identification device 200 includes a first sensor 210a (e.g. receiver), a first amplifier 220a, a first analog/digital (A/D) converter 230a, a second sensor 210b (e.g., receiver), a second amplifier 220b, a second A/D converter 230b, a control device 240 (e.g., controller), and a communication device 250 (e.g., communicator).

The first sensor 210a has a configuration in which a plurality of photodiodes is arranged. The first sensor 210a receives infrared rays, converts the received infrared rays into an electrical signal, and supplies the electrical signal to the first amplifier 220a which may include a plurality of amplifiers.

The first amplifier 220a amplifies the electrical signal to obtain a power level that may be used for an interpretation of the infrared rays received by the first sensor 210a, and supplies the amplified electrical signal to the first A/D converter 230a which includes a plurality of unit A/D converters.

The first A/D converter 230a converts a signal supplied from the first amplifier 220a, which is an analog signal, into a digital signal. Furthermore, the first A/D converter 230a transmits the digital signal obtained by the conversion to the control device 240.

The first sensor 210a may be implemented as, for example, an image sensor such as a charge-coupled device (CCD) camera. In this case, a function of the first amplifier 220a and a function of the first A/D converter 230a are included in the first sensor 210a.

Also, the second sensor 210b may be implemented as, for example, one photodiode, and receives an optical signal emitted from the display 140a, 140b, or 140c and converts the received optical signal into an electrical signal. In addition, the second sensor 210b supplies the electrical signal to the second amplifier 220b.

The second amplifier 220b amplifies the electrical signal to obtain a power level that may be used for interpretation of the optical signal received by the second sensor 210b, and supplies the amplified electrical signal to the second A/D converter 230b.

The second A/D converter 230b converts the signal supplied from the second amplifier 220b, which is an analog signal, into a digital signal. Furthermore, the second A/D converter 230b transmits the digital signal obtained by the conversion to the control device 240.

By such a configuration, the digital signal corresponding to the infrared rays received by the first sensor 210a and the digital signal corresponding to the optical signal received by the second sensor 210b are input to the control device 240.

The control device 240 may be implemented as a central processing unit (CPU) or various memories necessary for an operation of the CPU, and controls the overall operation of the identification device 200.

For example, the control device 240 interprets a digital signal input from the first A/D converter 230a and recognizes a pattern formed on the surface of the display device 140a, 140b, or 140c. Various types of technologies may be used to perform a method of recognizing a pattern formed on the surface of the display device 140a, 140b, or 140c, and for example, a pattern may be recognized by using edge detection. In addition, the control device 240 specifies a position at which the recognized pattern is placed on the display 140a, 140b, or 140c. In this manner, the control device 240 may specify the position of the identification device 200 on the display device 140a, 140b, or 140c. The control device 240 may also specify the movement of the identification device 200 by continuously specifying the position of the identification device 200.

In addition, the control device 240 interprets the digital signal input from the second A/D converter 239b and identifies the display 140a, 140b, or 140c toward which the front end portion of the identification device 200 is directed. For example, the control device 240 obtains a frequency spectrum of the optical signal received by the second sensor 210b by processing the digital signal input from the second A/D converter 230b by using a frequency analysis technique, such as, for example, Fast Fourier Transformation (FFT). According to an exemplary embodiment, the control device 240 may obtain only the intensity of a frequency component corresponding to each of the frequencies f1, f2, and f3, although it is understood that the control device 240 may obtain other information according to other exemplary embodiments. The control device 240 regards the display device 100a, 100b, or 100c, which generates a sinusoidal wave signal having a frequency component of a maximum intensity from among the frequencies f1, f2, and f3, as a display device toward which the front end portion of the identification device 200 is directed.

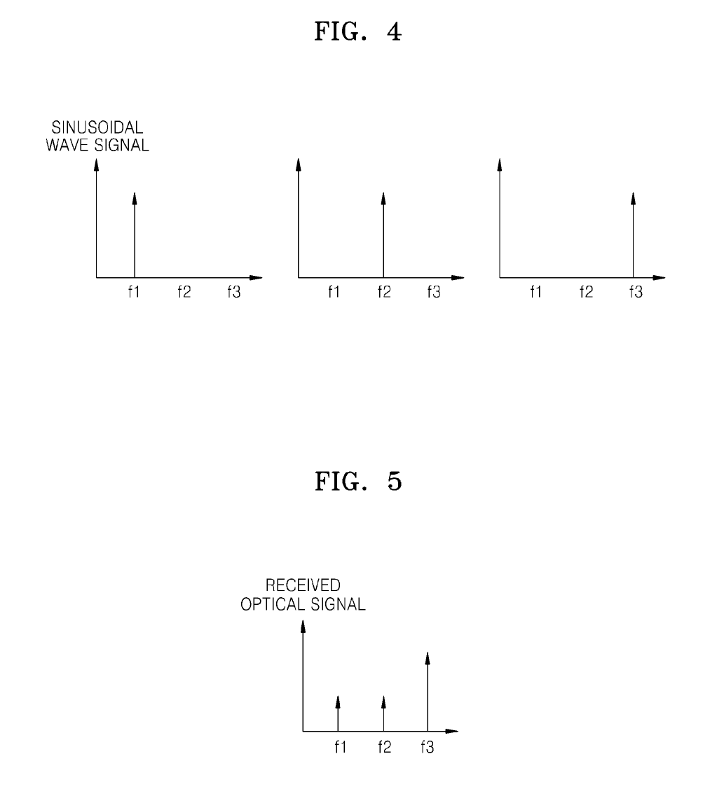

Below, the display identification system 1 according to the exemplary embodiment is further described with reference to FIGS. 4 and 5.

FIG. 4 shows graphs illustrating frequency spectra of sinusoidal wave signals that are generated by the sinusoidal wave generators 110a, 110b, and 110c, respectively. FIG. 5 is a graph illustrating a frequency spectrum of an optical signal received by the identification device 200.

The first sinusoidal wave generator 110a generates a sinusoidal wave signal having the frequency f1, and thus, a frequency spectrum of the sinusoidal wave signal that is generated by the first sinusoidal wave generator 110a is represented as a graph illustrated in the left side diagram of FIG. 4. The second sinusoidal wave generator 110b generates a sinusoidal wave signal having the frequency f2, and thus, a frequency spectrum of the sinusoidal wave signal that is generated by the second sinusoidal wave generator 110b is represented as a graph illustrated in the middle diagram of FIG. 4. Similarly, the third sinusoidal wave generator 110c generates a sinusoidal wave signal having the frequency f3, and thus, a frequency spectrum of the sinusoidal wave signal that is generated by the third sinusoidal wave generator 110c is represented as a graph illustrated in the right side diagram of FIG. 4.

When the identification device 200 is used in a state in which the identification device 200 contacts the surface of the display device 100, the identification device 200 may detect only a few frequency spectra as illustrated in FIG. 4.

When the identification device 200 is used in a state in which the identification device 200 is spaced apart from the display device 100 without contacting the surface of the display device 100, the identification device 200 may receive a plurality of frequency spectra from a plurality of display devices. For example, as illustrated in FIG. 5, when the frequency f3 is a frequency component of a maximum intensity, the control device 240 determines that the third display device 100c is located at a frontward direction toward which the front end portion of the identification device 200 is directed.

In addition, the control device 240 transmits an indication to the communication device 250 indicating an identification number allocated to a display device toward which the front end portion of the identification device 200 is directed.

The communication device 250 is an interface that independently communicates with each of the display devices 100a, 100b, and 100c. For example, the communication device 250 transmits, by wireless communication, an identification number which the communication device 250 is informed about from the control device 240, to the display device 100a, 100b, or 100c that is identified by the identification number. According to an exemplary embodiment, the communication device 250 may transmit the identification number along with additional information. For example, the communication device 250 may add an operational signal for operating the display device 100a, 100b, or 100c, which is identified by the identification number, to the identification number. The operational signal includes, for example, a signal for changing a channel, a signal for changing a volume, or a signal for many other different types of operations.

Although not illustrated in FIG. 1, each of the display devices 100a, 100b, and 100c includes a communication device for communicating with the identification device 200.

As described above, the display identification system 1 includes the display device 100 and the identification device 200. Particularly, the first display device 100a includes the backlight modulator 120a, and the backlight modulator 120a combines a specific signal, which is different from those of the other display devices 100b and 100c placed in a range of communication with the identification device 200, with a driving signal for driving the backlight 130a. Accordingly, an output light of the backlight 130a is luminance-modulated in a range in which a luminance change of the output light is not recognized by viewers. Similarly, in the second display device 100b, an output light of the backlight 130b is luminance-modulated with a specific signal that is different from those of the display devices 100a and 100c. Furthermore, in the third display device 100c, an output light of the backlight 130c is luminance-modulated with a specific signal that is different from those of the display devices 100a and 100b. As a result, the display devices 100a, 100b, and 100c may output respective optical signals each having luminances which are momentarily changed with different periods. In addition, the identification device 200 may identify the display device 100a, 100b, or 100c, toward which the front end portion of the identification device 200 is directed, by receiving an optical signal output from at least one of the display devices 100a, 100b, and 100c and interpreting the received optical signal.

In addition, according to the above-stated configuration, it is not necessary to additionally mount a signal device (for example, a wireless transmitter or an infrared transmitter) for identifying each of the display devices 100a, 100b, and 100c, and each of the display devices 100a, 100b, and 100c may be identified by using a simple configuration.

In addition, since luminance modulation is performed with a relatively high frequency without changing an average luminance of each of the backlights 130a, 130b, and 130c, a luminance change is not recognized by viewers. That is, each of the display devices 100a, 100b, and 100c may be identified without influencing the quality of an image display.

In addition, the display device 100 and the identification device 200 may each include a component other than the components described above or may not include some of the components described above according to other exemplary embodiments.

In addition, although only three display devices 100a, 100b, and 100c and one identification device 200 are illustrated in FIG. 1, the exemplary embodiments are not limited thereto. That is, the display identification system 1 may include only two display devices or may include four or more display devices. Also, the display identification system 1 may include a plurality of identification devices.

The above-described exemplary embodiment is intended to exemplify the main concepts of the present disclosure, but does not limit the present disclosure. That is, the present disclosure may be embodied in many different forms and should not be construed as being limited to the exemplary embodiments set forth herein.

For example, although the above exemplary embodiment describes the case in which the identification device 200 is implemented as a light pen, the exemplary embodiments are not limited thereto. That is, the identification device 200 may be implemented as a mobile terminal or a remote controller. Examples of the mobile terminal include a mobile phone, a smart phone, a tablet-type personal computer (PC), a notebook PC, a personal digital assistant (PDA), an electronic paper, etc. That is, the mobile terminal may be implemented as many different types of mobile electronic devices regardless of a name and a form thereof.

In the above-described exemplary embodiment, the sinusoidal wave generators 110a, 110b, and 110c generate sinusoidal wave signals having different frequencies f1, f2, and f3, respectively. However, the exemplary embodiments are not limited thereto, and the sinusoidal wave generators 110a, 110b, and 110c may generate sinusoidal wave signals having different phases, respectively. In this case, the backlights 130a, 130b, and 130c of the display devices 100a, 100b, and 100c may output optical signals having different phases, respectively. The identification device 200 may identify the display device 100a, 100b, or 100c, toward which the front end portion of the identification device 200 is directed, by receiving the optical signals having the different phases and comparing the received optical signals with a sinusoidal wave signal having a reference phase.

In addition, the sinusoidal wave generators 110a, 110b, and 110c may generate sinusoidal wave signals having different amplitudes, respectively. In this case, the backlights 130a, 130b, and 130c of the display devices 100a, 100b, and 100c may output optical signals having different amplitudes, respectively. The identification device 200 may identify the display device 100a, 100b, or 100c, toward which the front end portion of the identification device 200 is directed, by receiving the optical signals having the different amplitudes and comparing the received optical signals with an amplitude value previously set for each of the display devices 100a, 100b, and 100c.

In addition, in the above-described exemplary embodiment, light that is output from each of the backlights 130a, 130b, and 130c is luminance-modulated by using a sinusoidal wave signal. However, the exemplary embodiments are not limited thereto. For example, a different ID number may be allocated to each of the display devices 100a, 100b, and 100c, and light that is output from each of the backlights 130a, 130b, and 130c may be luminance-modulated according to the corresponding ID number.

For example, a code having favorable correlation characteristics, such as a pseudo noise (PN) code or a Walsh code, may be used as the ID number that is allocated for each of the display devices 100a, 100b, and 100c, and a driving signal of each of the backlights 130a, 130b, and 130c may be modulated according to the code. In this case, an optical signal including a different non-return to zero (NRZ) signal or magnetic north (MN) signal for each display device 100a, 100b, and 100c is output. In this case, the identification device 200 may receive the optical signal including the NRZ signal or MN signal, and may extract an original PN code or Walsh code by using a plurality of correlators corresponding to each code. As a result, the display device 100a, 100b, or 100c toward which the front end portion of the identification device 200 is directed may be identified.

In addition, each of the sinusoidal wave generators 110a, 110b, and 110c may frequency-modulate or phase-modulate a driving signal of each of the backlights 130a, 130b, and 130c by using the ID number allocated to each of the display devices 100a, 100b, and 100c.

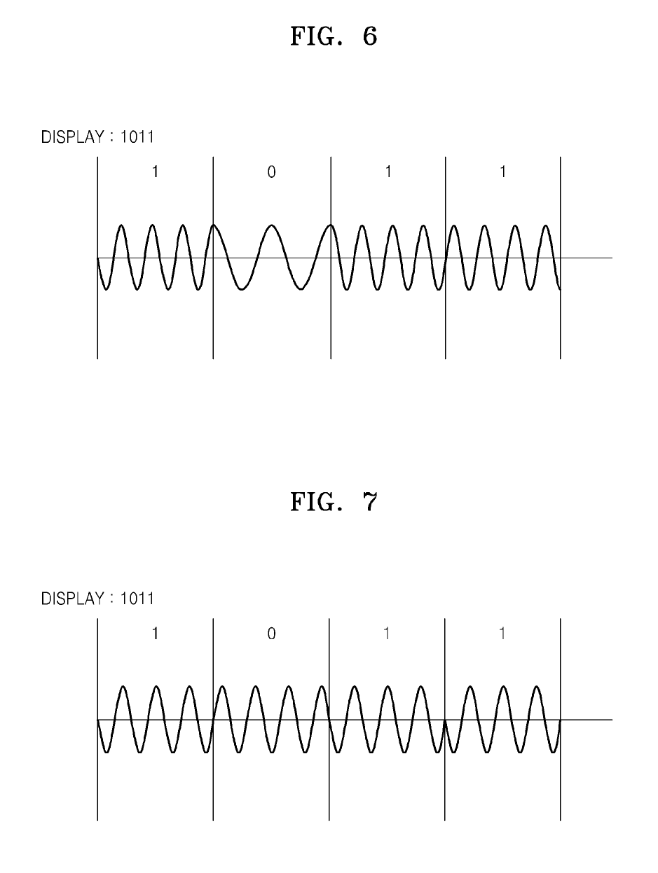

FIG. 6 is a diagram illustrating an example of a backlight (e.g., an optical signal) which is frequency-modulated by an ID number (e.g., a display ID). As illustrated in FIG. 6, an optical signal of each of the backlights 130a, 130b, and 130c is frequency-modulated so that a frequency of the optical signal is changed with respect to a predetermined time interval according to an ID number “1011”. Accordingly, the identification device 200 may extract an ID number by receiving a frequency-modulated optical signal and demodulating the received frequency-modulated optical signal. As a result, the identification device 200 may identify the display device 100a, 100b, or 100c, toward which the front end portion of the identification device 200 is directed, based on the demodulated optical signal.

FIG. 7 is a diagram illustrating an example of a backlight (e.g., an optical signal) which is phase-modulated by an ID number (e.g., a display ID). As illustrated in FIG. 7, an optical signal of each of the backlights 130a, 130b, and 130c is phase-modulated so that a phase of the optical signal is changed with respect to a predetermined time interval according to an ID number “1011”. Accordingly, the identification device 200 may extract an ID number by receiving a phase-modulated optical signal and demodulating the received phase-modulated optical signal. As a result, the identification device 200 may identify the display device 100a, 100b, or 100c, toward which the front end portion of the identification device 200 is directed, based on the demodulated optical signal.

The configuration of the display identification system 1 described above is provided to explain the main components thereof, but the exemplary embodiments are not limited to the configuration described above. In addition, the exemplary embodiments do not exclude other configurations in which the display device 100 and the identification device 200 are generally included among other components.

In addition, each functional configuration of the display identification system 1 is classified according to a main processing function to enable each functional configuration to be easily understood. The exemplary embodiments are not limited according to a method of classifying components and the names of the components. Each functional configuration may be divided into additional components according to a processing function. In addition, one component may be classified to execute additional processing functions.

In addition, the control device 240 of the identification device 200 may be implemented with a dedicated hardware circuit other than a CPU. For example, the control device 240 may be implemented with a single hardware circuit or a plurality of hardware circuits.

In addition, although the exemplary embodiments described above relate to an example in which the display devices 100a, 100b, and 100c are arranged side by side in an IWB, the plurality of display devices 100a, 100b, and 100c may be disposed in differently arranged positions.

In addition, although in the exemplary embodiment described above, an LCD having a backlight is described, other types of displays, such as, for example, an organic EL display, may be used. In this case, since the organic EL display is a spontaneous emission type, the organic EL display does not need to be equipped with a backlight and the same effect may be obtained by combining a specific signal, which is different for each of the display devices 100a, 100b, and 100c, with a driving signal for controlling the organic EL display to emit light.

While the present disclosure has been particularly shown and described with reference to exemplary embodiments thereof, it will be understood by those of ordinary skill in the art that various changes in form and details may be made therein without departing from the spirit and scope of the present disclosure as defined by the following claims.

What is claimed is:

1. A display identification system comprising:
a plurality of display devices, each of the display devices having a light source; and
an identification device configured to identify the plurality of display devices,
wherein each of the plurality of display devices comprises a modulator configured to perform luminance modulation to luminance-modulate an output light of the corresponding light source in a predetermined range, by combining a specific signal, which is different for each of the display devices, with a driving signal of the corresponding light source, and wherein the identification device comprises:
a receiver configured to receive an optical signal obtained by performing the luminance modulation; and
an identification device configured to identify each of the plurality of display devices based on the optical signal received by the receiver.

2. The display identification system of claim 1, wherein the modulator uses a sinusoidal wave signal having a different frequency for each of the display devices as the specific signal.

3. The display identification system of claim 1, wherein the modulator uses a sinusoidal wave signal having a different phase for each of the display devices as the specific signal.

4. The display identification system of claim 1, wherein the modulator uses a signal modulated with a different code for each of the display devices as the specific signal.

5. The display identification system of claim 1, wherein the modulator uses a signal modulated with a different identification (ID) number for each of the display devices as the specific signal.

6. The display identification system of claim 1, wherein the identification device is configured to identify each of the plurality of display devices by analyzing a frequency component of the optical signal received by the receiver.

7. The display identification system of claim 1, wherein the identification device comprises one of a light pen, a mobile terminal, and a remote controller.

8. The display identification system of claim 1, wherein the identification device further comprises a transmitter configured to add distinctive information to an operational signal to be transmitted to an identified display device to operate the identified display device and transmit the operational signal to the identified display device.

9. A display device configured to be identified by an identification device, the display device comprising:
a light source; and
a modulator configured to perform luminance modulation to luminance-modulate an output light of the light source in a predetermined range, by combining a specific signal, which is different from another signal employed by another display device placed in a range of communication with the identification device, with a driving signal of the light source.

10. The display device of claim 9, wherein the modulator uses a sinusoidal wave signal having a frequency, which is different from a frequency of the other signal employed by the other display device, as the specific signal.

11. The display device of claim 9, wherein the modulator uses a sinusoidal wave signal having a phase, which is different from a phase of the other signal employed by the other display device, as the specific signal.

12. The display device of claim 9, wherein the modulator uses a signal modulated with a code, which is different from a code used to modulate the other signal of the other display device, as the specific signal.

13. The display device of claim 9, wherein the modulator uses a signal modulated with an identification (ID) number, which is different from an ID number used to modulate the other signal of the other display device, as the specific signal.

14. An identification device configured to identify a display device, the identification device comprising:
a receiver configured to receive a luminance-modulated optical signal;
a controller configured to identify the display device based on the optical signal received by the receiver and to generate and transmit an identification number of the display device; and
a communicator configured to receive the identification number of the display device from the controller, and transmit the identification number to the display device.

15. The identification device of claim 14, wherein the communicator is configured to add an operational signal for operating the display device to the identification number and transmit the identification number along with the added operational signal to the display device.

16. The identification device of 14, wherein the controller is configured to identify the display device by analyzing a frequency component of the optical signal received by the receiver.

17. The display identification system of claim 1, wherein the predetermined range is a range in which a luminance change of the output lights is not recognized by viewers.

18. The display device of claim 9, wherein the predetermined range is a range in which a luminance change of the output light is not recognized by viewers.

19. A display identification system, comprising:
a plurality of display devices; and
a remote input device configured to wirelessly communicate with the plurality of display devices to thereby control the plurality of display devices to display information corresponding to a movement of the remote input device,
wherein each of the display devices comprises a signal generator configured to generate a unique signal identifying the respective display device, and transmit the unique signal to the remote input device.

20. The display identification system of claim 19, wherein each of the display devices comprises a sinusoidal wave generator configured to generate a sinusoidal wave having a unique characteristic identifying the respective display device.

21. The display identification system of claim 20, wherein the unique characteristic comprises at least one of a frequency, an amplitude, and a phase of the sinusoidal wave.

22. The display identification system of claim 19, wherein each of the unique signals falls within a frequency range determined according to a type of the display devices.

23. The display identification system of claim 22, wherein the type of the display devices comprises a liquid crystal display (LCD) type.

24. The display identification system of claim 19, wherein the remote input device is configured to receive the unique signal and detect one of the display devices which a front portion of the remote input unit is primarily pointed towards, as compared to the other display devices which the front portion is not primarily pointed towards, based on the unique signal.

25. The display identification system of claim 24, wherein the remote input device comprises a communicator configured to transmit an identification of the detected display device to the detected display device, and
the detected display device is configured to display the information corresponding to the movement of the remote input device in response to receiving the identification from the remote input device.

26. The display identification system of claim 25, wherein the information corresponds to shapes corresponding to the movement of the remote input device.

27. The display identification system of claim 26, wherein the remote input device comprises a light pen.
